(19) United States
(12) Patent Application Publication
(10) Pub. No.: US 2005/0027597 A1
(43) Pub. Date: Feb. 3, 2005

(54) Method for establishing cooperative marketing groups

(76) Inventor: Michael W. Peterson, Minneapolis, MN (US)

Correspondence Address: DORSEY & WHITNEY LLP;INTELLECTUAL PROPERTY DEPARTMENT, 50 SOUTH SIXTH STREET, MINNEAPOLIS, MN, 55402-1498, US

(21) Appl. No.: 10/878,483

(22) Filed: Jun. 28, 2004

Related U.S. Application Data
(60) Provisional application No. 60/482,877, filed on Jun. 26, 2003.

(51) Int. Cl. G06F 17/60

(52) U.S. Cl. 705/14

(57) ABSTRACT

The present invention relates to a method of marketing. The method includes collecting customer information from at least two merchants, categorizing the customer information into at least two predetermined categories, and distributing a promotion to at least one of the at least two categories.

### CROSS-REFERENCE TO RELATED APPLICATION

This application claims priority from U.S. Provisional Application No. 60/482,877, entitled “Method for Establishing Cooperative Marketing Groups,” by Michael W. Peterson, filed Jun. 26, 2003, the contents of which are hereby incorporated in their entirety.

### FIELD OF THE INVENTION

The present invention relates to marketing method. More specifically, the present invention relates to a community marketing method providing for low-cost identification, acquisition, and retention of customers.

### BACKGROUND OF THE INVENTION

A customer retention program is a common method for a merchant to maintain its visibility with its existing customers. Typically, the program provides for the merchant gathering information from existing customers and utilizing that information to send promotional information to those customers.

Another common marketing practice is the pooling of resources to produce promotional materials, sometimes called “coop marketing.” That is, two or more merchants reduce their market expenses by combining resources to create promotional materials or advertisements that feature or promote each merchant's business, thereby reducing the costs for each individual merchant.

There is a need in the art for a marketing system that provides for combining both resources and marketing information and thereby reducing marketing expenses and efforts.

### BRIEF SUMMARY OF THE INVENTION

The present invention, in one embodiment, is a method of community marketing. The method includes collecting customer information from at least two merchants and categorizing the customer information into at least two predetermined categories. The method further includes distributing a promotion to at least one of the at least two categories and collecting statistics related to the distributing of the promotion. Further, the method includes optimizing the method of community marketing based on the statistics.

The present invention, in another embodiment, is a method of marketing. The method includes collecting customer information from at least two merchants and categorizing the customer information into at least one predetermined merchant category and into at least one predetermined community category. The method also includes distributing a promotion to customers in at least one of the at least one predetermined merchant category or the at least one predetermined community category. In addition, the method includes collecting statistics related to the distributing of the promotion and optimizing the method of community marketing based on the statistics.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a flow chart depicting a method of implementing a marketing system, according to one embodiment of the present invention.

FIG. 2A is a flow chart illustrating various methods of collecting customer information, according to one embodiment of the present invention.

FIG. 2B is a flow chart showing a method of collecting customer information at merchant locations, according to one embodiment of the present invention.

FIG. 2C is an illustration showing a contest entry form, according to one embodiment of the present invention.

FIG. 2D is an illustration depicting the front and back of a comment card and contest form, according to one embodiment of the present invention.

FIG. 2E is an illustration showing the front and back of a display, according to one embodiment of the present invention.

FIG. 2F is a flow chart depicting a method of collecting customer information at a website, according to one embodiment of the present invention.

FIG. 2G is an illustration of a website screenshot allowing for collection of customer information, according to one embodiment of the present invention.

FIG. 2H is a flow chart illustrating a method of collecting customer information at an electronic device, according to one embodiment of the present invention.

FIG. 2I is a flow chart showing a method of collecting customer information with a survey, according to one embodiment of the present invention.

FIG. 3 is a flow chart depicting a method of processing the customer information, according to one embodiment of the present invention.

FIG. 4 is a flow chart illustrating a method of distributing merchant promotions to customers in a community, according to one embodiment of the present invention.

FIG. 4A is an illustration of a website screenshot containing a community promotion, according to one embodiment of the present invention.

FIG. 5 is a flow chart showing a method of distributing promotions to customers on a merchant list, according to one embodiment of the present invention.

FIG. 5A is an illustration depicting a merchant promotion, according to one embodiment of the present invention.

FIG. 6 is an illustration depicting a statistical report for a merchant, according to one embodiment of the present invention.

FIG. 7 is an illustration depicting a statistical report for a merchant, according to an alternative embodiment of the present invention.

### DETAILED DESCRIPTION

The present invention is a novel marketing system allowing for effective customer identification, acquisition, and retention without extensive effort or expense on the part of any individual participating merchant. According to one embodiment, the marketing system of the present invention allows businesses, including small businesses with limited marketing budgets, to contact and acquire new customers that live, work, or shop in the business' geographic area. The system can also help businesses to stay visible to existing customers, regardless of their geographic location.

According to one embodiment, the present invention provides for an aggregation of customer information. The aggregated information can be utilized by each participating merchant without compromising any merchant's confidential customer lists or data. That is, a marketing system provider collects and organizes customer information such that any merchant participating in the system can reach every customer in the aggregation of customer information through advertising without allowing access to any individual merchant's proprietary or confidential customer lists or data. Thus, according to one embodiment, the marketing system of the present invention allows for secure pooling of more than one merchant's customer data or lists into customer information as understood herein without compromising any merchant's confidential information.

A “marketing system provider” is any entity that controls, maintains, or assists in any way with the operation of a marketing system of the present invention. According to one embodiment, the marketing system provider is a third party, non-merchant entity.

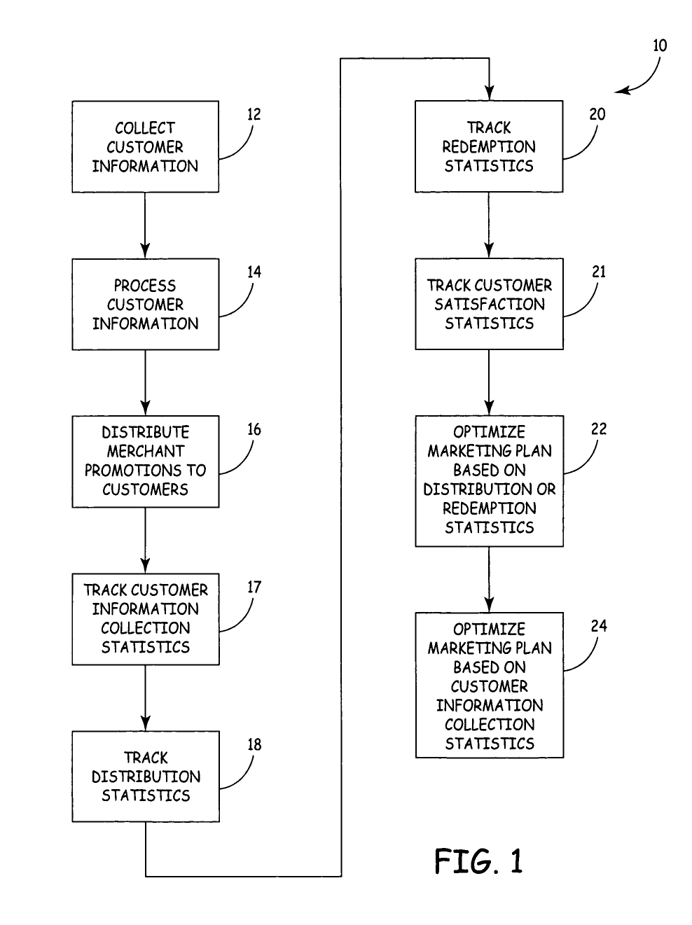

FIG. 1 depicts a method of implementing a marketing system 10, according to one embodiment of the present invention. The method includes collecting customer information (block 12), processing the customer information (block 14), and distributing merchant promotions to customers (block 16). After distribution, the method in one embodiment can include tracking customer information collection statistics (block 17), tracking distribution statistics (block 18), tracking redemption statistics (block 20), and tracking customer satisfaction statistics (block 21). In addition, the method according to one aspect of the invention includes optimizing the marketing plan based on the distribution or redemption statistics (block 22). In a further embodiment, the method includes optimizing the collection of customer information (block 24).

For purposes of this application, “customer information” is any information relating to a customer and can include a customer name, street address, e-mail address, phone number, and any other contact information or demographic information. The customer information, according to one embodiment, can further include any information relating to a customer's interests or preferences, including, but not limited to, identified interests or preferences relating to certain merchants, shopping areas, communities as defined herein, products, services, industries, hobbies, sporting or recreation activities or events, travel, professional services, family-related products, services, activities or events, cultural activities or events, dining establishments, publications, education and training, automotive products and services, or any other preferences or interests. “Customer” shall refer to any person who has purchased goods or services at a participating merchant, has indicated an interest in a particular merchant or particular products or services, or who has provided customer information for use with the present invention. “Customer” includes a prospective customer.

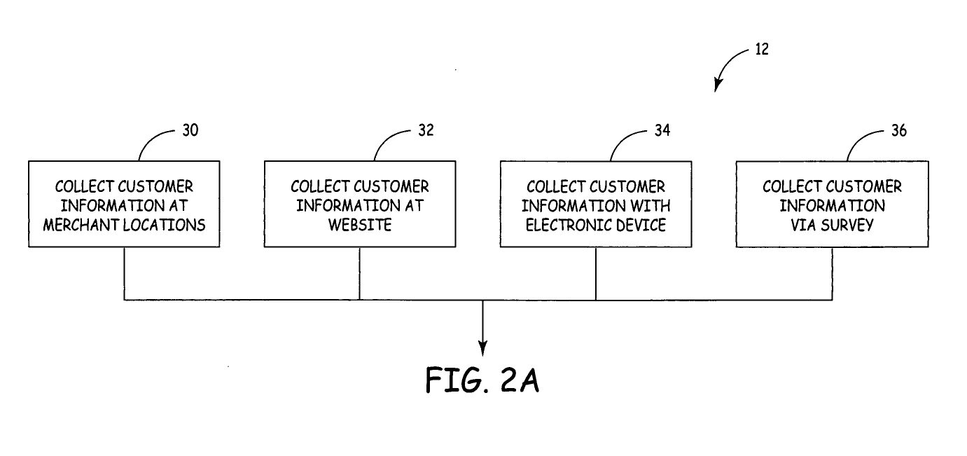

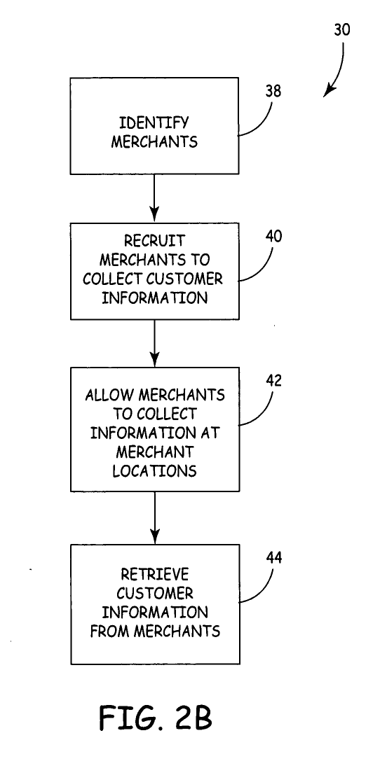

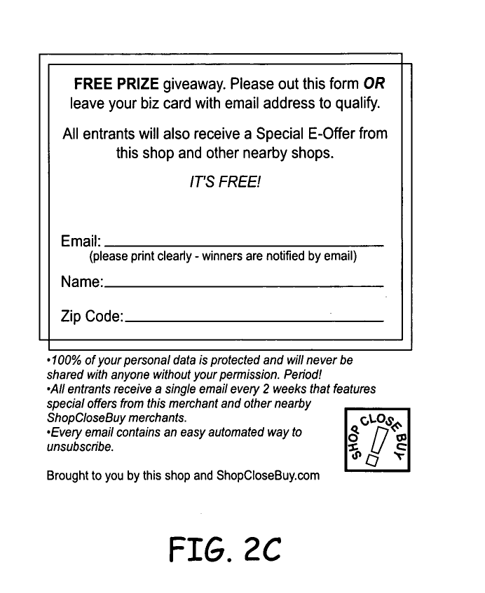

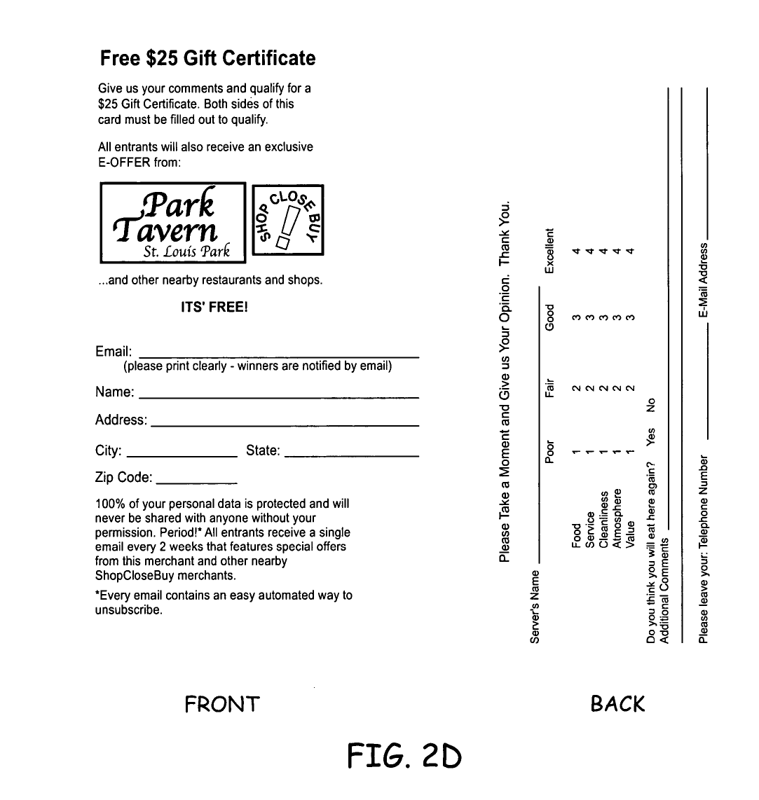

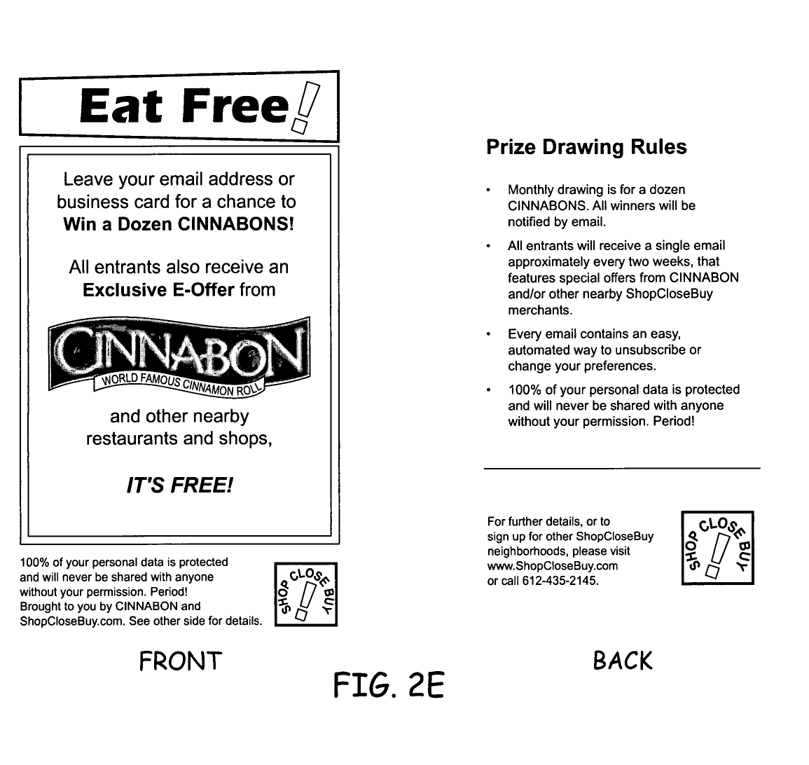

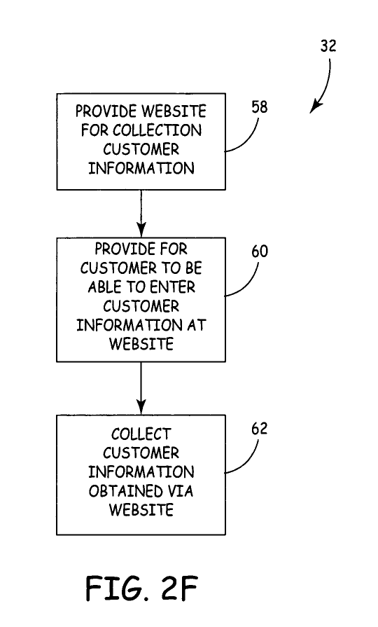

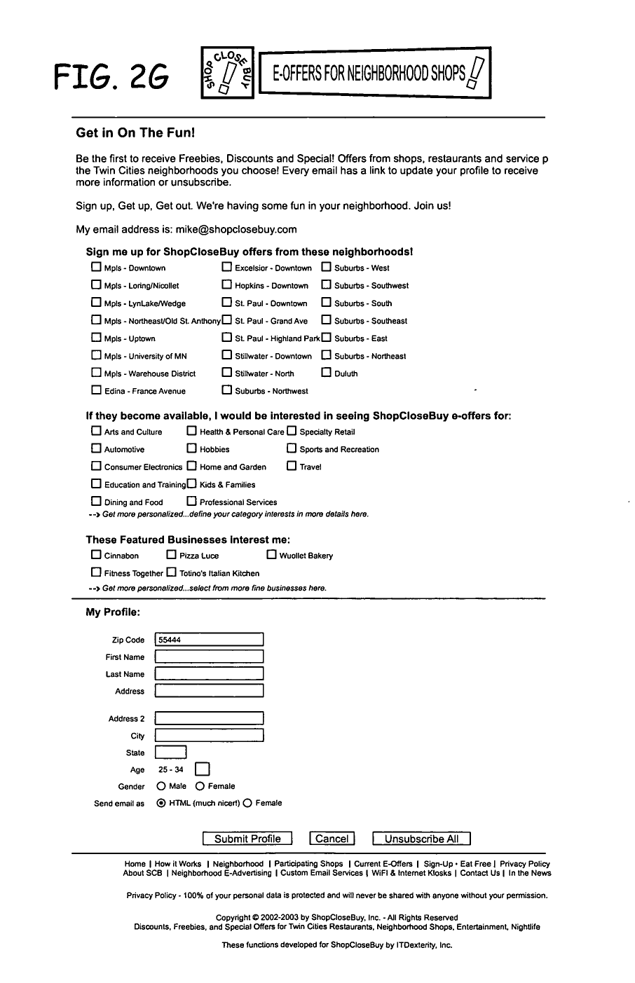

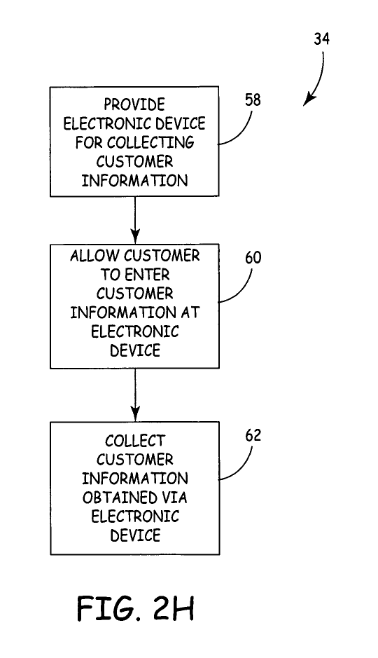

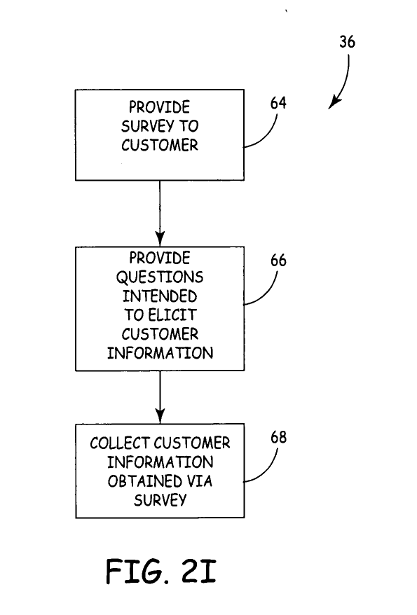

Collecting customer information 12 can occur by various different methods. FIG. 2A depicts four different methods of collecting customer information 12, according to one embodiment of the present invention. For example, customer collection can occur according to one embodiment by collecting customer information at merchant locations (block 30). According to an alternative embodiment, customer information collection can occur by collecting customer information at a website (block 32). For example, the website could be the system provider's website, a merchant website, or any third party provider website. In a further alternative, customer information collection can occur by collecting customer information at an electronic device (block 34). For example, the electronic device can be a web-enabled kiosk. In an alternative example, the electronic device is a computer. In a further alternative, the electronic device could be a device at the merchant location containing point-of-sale software. “Point-of-sale” software is known software that provides for collecting customer information. For example, according to one embodiment, the electronic device is a cash register containing point-of-sale software. Alternatively, the electronic device is any known electronic device allowing for input of information. In a further aspect of the present invention, the customer information can be collected via a customer survey (block 36). For example, the customer survey can be a written survey. In a further alternative, the customer information can be collected by any combination of the above methods. Further, the customer information can be collected by any other known method of collecting information for marketing purposes.

FIG. 2B depicts one method of collecting customer information at merchant locations 30, according to one embodiment of the present invention. In one aspect of the invention, customer information is collected from more than one merchant or collected from each merchant in more than one way. According to this method, merchants are first identified (block 38). For purposes of this application, “merchant” is intended to mean any commercial entity of any kind that sells any kind of product or service to customers. The merchants can be identified based on geographic location, type of merchant, or any other relevant factor. Identified merchants are then recruited to participate in the marketing system and collect customer information (block 40). The merchants can be recruited by contacting individual merchants, by advertising and allowing merchants to contact the marketing system provider, by partnering with an association, such as a business association, chamber of commerce, etc., by partnering with a parent company, franchisor, or any other large entity with relationships with several smaller entities, or by any other known method of recruiting merchants.

Once recruited, the participating merchants are allowed or provided with the tools to collect customer information at each merchant location (block 42). According to one embodiment, each merchant can, with or without the help of the marketing system provider, have a contest. The contest can be any contest that provides for customer registration or sign-up that allows for collection of contact information from the customer. In one contest example, registration includes the customer simply providing a business card. In another contest example, the customer provides her or his e-mail address. For example, the contest could be a drawing for a prize, wherein the prize can be provided by the merchant or alternatively by the marketing system provider. Alternatively, each merchant can, with or without the help of the marketing system provider, collect customer information by any known method. An exemplary contest entry form allowing for entry of certain customer information is depicted in FIG. 2C.

According to one alternative aspect of the present invention, the step of allowing the participating merchant to collect customer information (block 42) can include utilizing a comment card or similar information collection device provided for the customer to fill out. For example, a comment card requesting customer information can be provided with the customer's bill. In an alternative embodiment, the merchant can collect customer information using a comment card that also provides for entry into a contest. One exemplary embodiment of a comment card/contest form that can be provided to a customer is depicted in FIG. 2D, which shows the front and back side of a comment card that provides for entry of the customer's name into a contest for a $25 gift certificate.

Alternatively, the step of allowing the participating merchant to collect customer information (block 42) can include providing the merchant with a display at the merchant location (sometimes referred to as a “point of purchase” display) that allows any customer to provide contact information. For example, the display may provide a location for the customer to leave her or his business card. According to one embodiment, the location is known as a “fishbowl.” In another alternative example, the display may provide a registration form which the customer can fill out with contact information. An exemplary display, including the front and back portions of the display, is depicted in FIG. 2E.

In a further alternative, the step of allowing the participating merchant to collect customer information (block 42) can include providing the merchant with registration forms to provide to customers. Any interested customer can then simply enter contact information onto the registration form.

In yet another alternative, the step of allowing the participating merchant to collect customer information (block 42) can include providing the merchant with or allowing the merchant to acquire an electronic device for entry of customer information. For example, the electronic device can be a web-enabled kiosk, such as the kiosks provided by Talkingpoint Inc., Minneapolis, Minn. (www.talkingpoint.com) or an Internet kiosk, such as the kiosks provided by Surfthing, LLC, Minnesota (www.surfthing.com). In an alternative example, the electronic device is a computer. In yet another alternative, the electronic device contains point-of-sale software as described further herein that allows for collection of customer information. According to one embodiment, the device with the point-of-sale software is a cash register. In one example, the customer can use a “loyalty” credit card or I.D. card that is associated with a marketing system or system provider according to the present invention and provides predetermined discounts to the customer using the card and further operates in conjunction with the point-of-sale software to provide customer information relating to any purchase made using the card at a participating merchant. Such “loyalty” cards are well known in the art. One example of a “loyalty” card is a membership discount card for a chain of grocery stores. In use, the card is displayed at the time of purchase and an automatic discount is provided. Similarly, a “loyalty” card associated with the present invention can be presented at a participating merchant for predetermined discounts. Alternatively, the electronic device is any known electronic device allowing for input of information.

The customer information is then sent, retrieved, or collected from each merchant (block 44). According to one embodiment, the customer information is retrieved on a periodic basis, such as every two weeks or every four weeks, for example. In one embodiment, the information is collected from each merchant by having the merchant send the information to the system provider. For example, the merchant can send the information to the system provider by standard mail. In another example, the merchant can e-mail the information to the system provider. In a further example, the merchant can send the information to the system provider by any known method. In accordance with an alternative aspect of the present invention, the customer information can be automatically transmitted to the system provider. For example, the customer information can be automatically transmitted electronically by known methods of automatic electronic transmission of information. Alternatively, the system provider can travel to each merchant and collect the customer information. In an alternative in which a customer uses a loyalty credit card or I.D. card associated with a marketing system of the present invention that provides predetermined discounts at participating merchants (or any other type of credit card), the customer information can be collected by the financial institution or company that provides the card or by any other known method of collecting information relating to the use of a card. In a further alternative, the customer information can be retrieved or collected by any known method.

In accordance with one aspect of the invention, the customer information can be collected in a different fashion. FIG. 2F depicts a method of collecting customer information at a website 32, according to one embodiment of the present invention. In this embodiment, a website is provided for collecting customer information (block 50). The website provides for a customer to be able to enter customer information at the website (block 52). An exemplary website screenshot providing for entry of various information and preferences is depicted in FIG. 2G. Once the information is entered by the customer at the website, the information is collected from the website (block 54). The information is collected from the website in any known fashion for retrieving information entered at a website. According to one embodiment, the website is accessed by the customer on a computer. Alternatively, the website can be accessed at an Internet kiosk. Alternatively, the website can be accessed in any known fashion for accessing a website.

In accordance with an alternative aspect of the invention, the customer information can be collected in a different fashion. FIG. 2H depicts a method of collecting customer information at an electronic device 34, according to one embodiment of the present invention. In this embodiment, an electronic device is provided for collecting customer information (block 58). The electronic device is, in one aspect of the invention, located at the merchant location. Alternatively, the electronic device can be located where customer information can be collected. According to one embodiment, the electronic device is a web-enabled kiosk, such as the kiosks provided by Talkingpoint Inc. or Surfthing, LLC. In an alternative example, the electronic device is a computer. In one embodiment, the computer is a handheld computer. In a further alternative, the electronic device is any known electronic device allowing for input of information.

The customer is allowed to enter customer information at the electronic device (block 60). Once the information is entered by the customer at the electronic device, the information is collected from the electronic device (block 62). The information is collected from the electronic device in any known fashion for retrieving information from an electronic device. For example, where the electronic device is a web-enabled kiosk, the information is retrieved over the Internet.

In an alternative embodiment, the customer information can also be collected in yet another manner. FIG. 21 depicts a method of collecting customer information with a survey 36, according to one embodiment of the present invention. In this embodiment, the survey is provided to the customer (block 64). The survey can be in any known survey format and can be provided in any known fashion. For example, the survey can be taken by a marketing professional in a public location such as a shopping mall. In an alternative example, the survey can be taken by mailing a survey to prospective customers. In a further example, the survey is taken via e-mail. When the survey is taken by e-mail, one embodiment provides for a link to a website where the survey can be taken. Alternatively, the survey can be embedded into the e-mail. In an alternative aspect, the survey is taken at a website. The website can be owned or operated by the merchant, the marketing system provider, or a third party. In yet another example, the survey is taken via a survey form provided with a bill or receipt at a merchant location during a purchase (also referred to as a “check insert”), such as the survey form depicted in FIG. 2D.

In the survey method, questions are provided to the customer to elicit customer information (block 66). When the survey is complete, the customer information obtained via the survey is collected (block 68). The customer information can be collected in any known fashion. For example, if the survey is taken by a marketing professional, the professional can provide the customer information.

In a further alternative embodiment, the customer information can be collected by any known fashion.

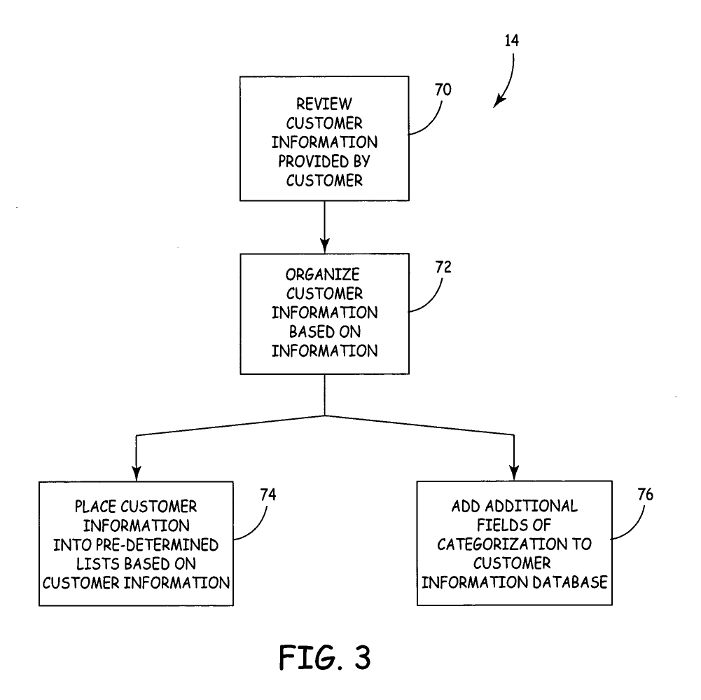

Once collected, the customer information is compiled and processed. FIG. 3 depicts a method of processing the customer information 14, according to one embodiment of the present invention. The customer information, according to one embodiment, is reviewed after it has been collected (block 70). Alternatively, the customer information need not be reviewed. The customer information is then organized based on the information that is contained therein (block 72).

In one aspect of the invention, the compilation, aggregation, or consolidation of the customer information in one location or database or by one entity includes securing or protecting the customer information from access by any participating merchant or any other entity other than the marketing system provider. That is, the security of the customer information is maintained to protect the confidential information of each of the participating merchants such that merchants are willing to participate in a system of the present invention without fear of competitors or any other companies or entities obtaining their confidential or proprietary customer data or lists. For example, according to one embodiment, the marketing system provider consolidates or compiles the customer information in the memory of a database on a computer that cannot be accessed by any entity or person other than authorized personnel of the provider. Alternatively, the customer information can be secured or protected in any known fashion.

According to one embodiment, the customer information is organized by placing it into predetermined lists or categories based on some of the information contained within the customer information itself (block 74). For example, the customer information may be separated into predetermined categories wherein the categories are community categories. For purposes of this application, “community” relates to customers sharing a common characteristic and “community category” is a compilation of customer information for each customer sharing a common characteristic. The common characteristic can relate to geographic location, shopping preferences, interest in products or services, or any other known characteristic. For example, the community category may be based on geography such that each customer living, working or shopping within a particular area is placed on the same list. Thus, the home or work address (or any other address provided by the customer) in the customer information can be used to determine which category in which to place a particular customer's information. In an alternative example, the community category may be based on an interest in a particular product. In a further alternative, the community category is based on any known factor for determining a community.

In an alternative aspect of the invention, the customer information is organized by placing it into predetermined lists or categories wherein the categories are merchant categories. A merchant category is a compilation of customer information for each customer or prospective customer that (1) has purchased products or services from a particular merchant, (2) has provided customer information to a particular merchant, either through a contest or any other known means, (3) is interested in potentially purchasing products or services from a particular merchant, or (4) lives, works, or shops in the area where the particular merchant is located. In a further alternative, the merchant category is a compilation of customer information for customers that the particular merchant is targeting. In yet another aspect of the invention, the merchant category can be determined based on any known factor.

In a further alternative embodiment of the present invention, the customer information is organized by placing it into predetermined lists or categories wherein the lists or categories are created based on any known factor, such as, for example, product and service preferences.

Alternatively to placing the customer information into predetermined lists or categories, the customer information can be organized by adding additional fields of categorization to each customer information entry in a database (block 76). For example, for organizing all the customer information based on community, each customer entry may have an extra field or extra fields added to the customer's information identifying the community or various communities to which the customer belongs. And for organizing based on merchant, each customer entry can also have an extra field identifying the merchant. Alternatively, any category can be provided in an extra field.

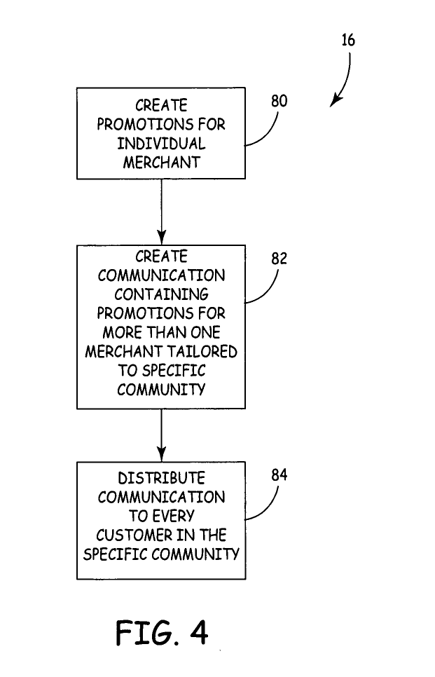

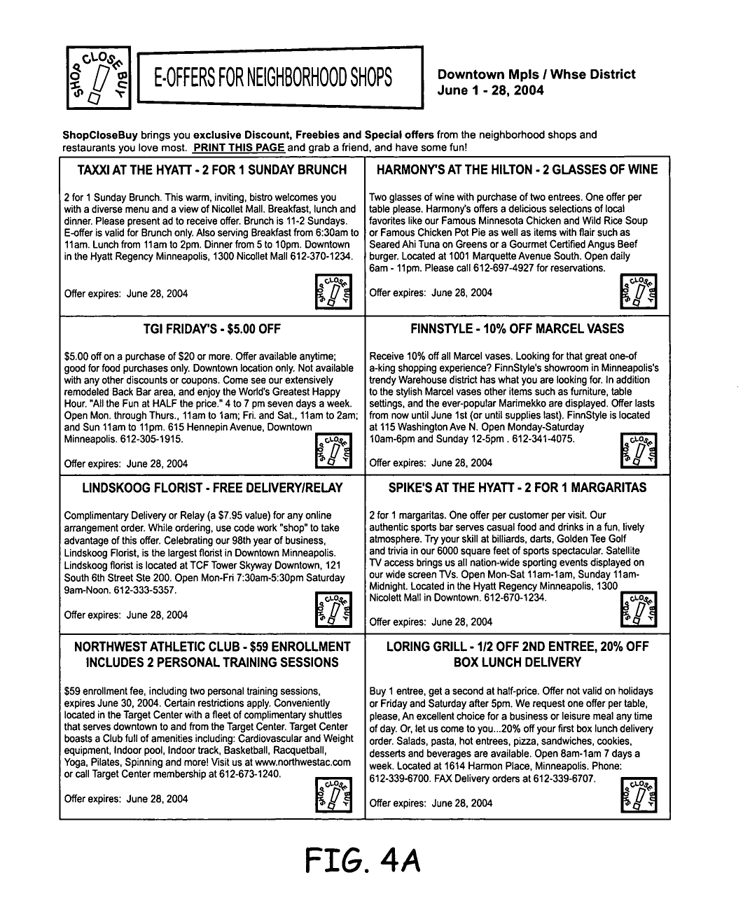

After collection and processing, it is possible to distribute promotional materials to the customers. FIG. 4 depicts a method of distributing more than one merchant promotion from more than one merchant to all participating customers in a community 16, according to one embodiment of the present invention. A promotion is first created for each merchant (block 80). The promotion can be a coupon, an advertisement, a discount offer, a voucher, a promotional announcement, an invitation to an event, or any other type of promotion. According to one embodiment, the merchant decides on and creates the promotion. Alternatively, the system provider decides on and creates the promotion. In a further alternative, the merchant and system provider work together to decide on and create the promotion. In yet another alternative, the promotion is created by a third party, such as an advertising company.

After the promotions have been created, a communication is created containing promotions for more than one merchant wherein the communication and promotions are tailored to a specific community (block 82). According to one embodiment, a typical communication contains more than one separate promotions from more than one separate merchants. In one embodiment, a communication containing more than one promotion from more than one merchant is a community communication or community promotion. Alternatively, the communication can contain anywhere from two to any number of separate promotions, each from separate merchants. In a further alternative, more than one promotion may be from a single merchant. According to an alternative embodiment, the promotions can also be made available at a website. An exemplary screenshot containing several separate promotions for separate merchants is depicted in FIG. 4A. A similar format can be used for a communication sent as an e-mail.

In an alternative aspect of the present invention, the communication can also contain additional information. For example, the communication can include a survey intended to elicit additional customer information from the customer. In another example, the communication can include announcements relating to additional information or special events related to the specific interest of the community to which the communication is being sent. For example, a community of customers interested in music may receive an announcement about an upcoming concert in a communication containing promotions relating to specials on CDs and stereo equipment.

The communication is an e-mail. Alternatively, the communication is a flyer sent by standard mail. In a further alternative, the communication can be in any known media format. For example, the communication could be a radio advertisement. In another example, the communication could be distributed and redistributed through a network. That is, the communication could be sent to a parent company or franchisor, which then could further distribute the communication to its subsidiary companies or franchisees, respectively. In a further example, the communication could be distributed door to door, in participating shops, or via public distribution such as simply handing it to people on a street corner.

Once the communication has been created, it is distributed to every participating customer in the specific community (block 84). According to one embodiment, the customers are identified based on a community list as created above, or based on customers in a database identified as belonging to that particular community. Alternatively, the customers are identified by any known means.

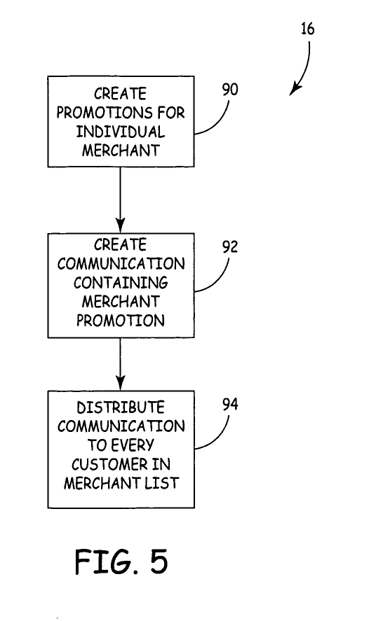

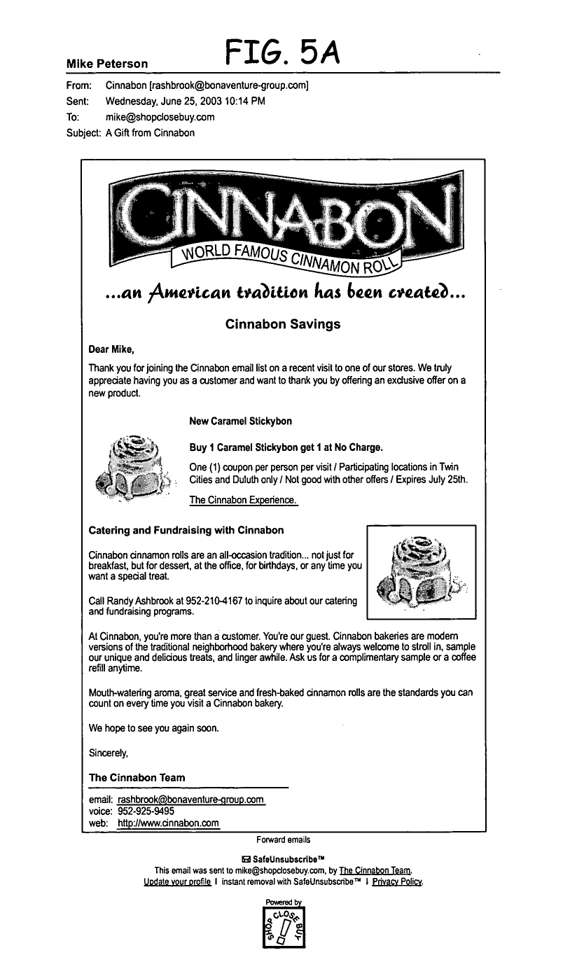

FIG. 5 depicts an alternative method of distributing promotions 16 according to one embodiment of the present invention, wherein the promotion distributed is from one merchant to all participating customers on a merchant list. In this embodiment, the promotion or more than one promotion is created for the merchant (block 90). The promotion or promotions can be created by any method as described above for promotion creation. A communication is then created containing the merchant promotion or promotions (block 92). The communication contains a promotion for the merchant. Alternatively, the communication contains more than one promotion for the merchant. In one embodiment, the communication is referred to as a merchant promotion or merchant communication. In a further alternative, the communication contains one or more additional promotions for additional merchants. According to one embodiment, the additional merchants are merchants in related or complementary industries or merchants selling related or complementary products or services. For example, a communication containing a promotion for a particular spa/salon may also include an additional promotion for a particular brand of beauty products. Alternatively, the additional merchants are unrelated or non-complementary businesses in a similar community, such as a similar geographical location. In the above example relating to the spa/salon, the communication may also include an additional promotion for a restaurant or any other merchant located near the spa/salon. The communication is an e-mail. Alternatively, the communication can be any known media format, as described above. An exemplary e-mail communication containing a promotion for a particular merchant is depicted in FIG. 5A.

Once the communication has been created, it is distributed to every participating customer on the merchant list or every customer in the customer information database having a field identifying the merchant (block 94). Alternatively, the communication is distributed to every customer who indicated an interest in the merchant or a product or service the merchant provides. In a further alternative, the communication is distributed to customers categorized in any other known fashion.

Returning to FIG. 1, according to one embodiment, customer information collection statistics can be tracked (block 17). The statistics that can be tracked include, but are not limited to, (1) the number of customers that provide information via the chosen collection method, (2) the amount of customer information provided by each customer via the chosen method, and (3) the “quality” of the customer information provided by each customer via the chosen method, where quality is a measure of information that is more likely to indicate whether the customer will purchase any products or services from a given merchant or participate in any given promotion. An example of “quality” information could be any customer information relating to preferences that indicate an interest in certain products, services, merchants, etc. For example, a customer information entry that includes interest in Italian food is a better predictor of the likelihood of that customer participating in a promotion relating to an Italian restaurant (and thus, higher “quality”) than information relating to the customer's marital status or home ownership. Alternatively, any known statistics related to the collection of customer information can be tracked.

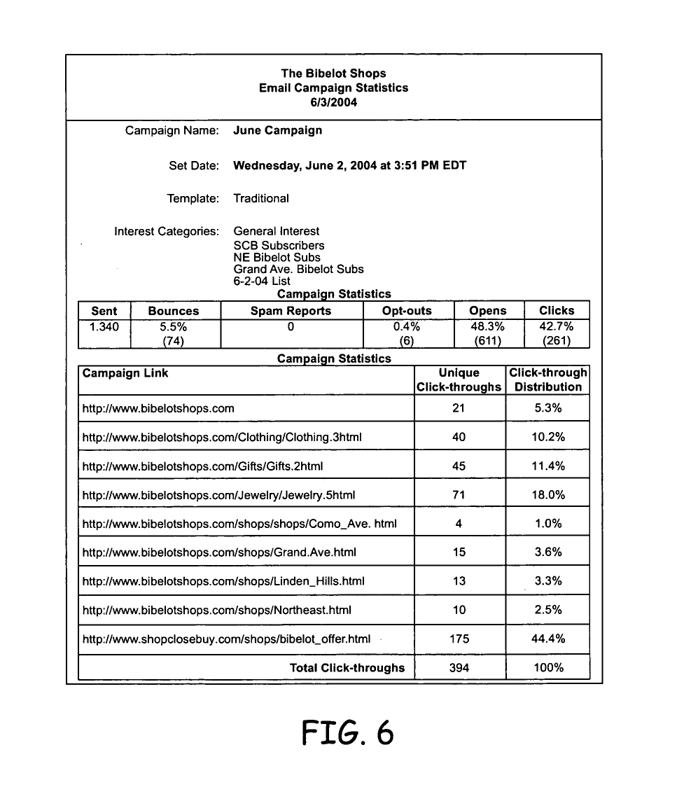

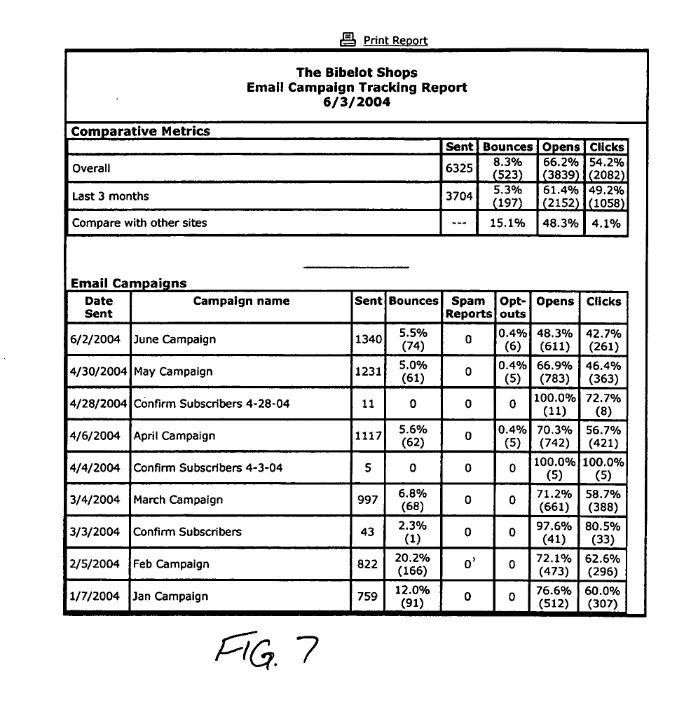

Further, once the communication is distributed, distribution statistics can be tracked (block 18) in one aspect of the invention. If the communication is an e-mail, the statistics that can be tracked include, but are not limited to, (1) the total number of e-mails sent for a promotion, (2) the number and identity of recipient customers who open the e-mail (also referred to as “opens”), (3) the date and time of day that the e-mail is opened, (4) a calculation of the percentage of total e-mails sent that are opened (also referred to as “opened percent”), (5) the number of e-mails that are not successfully received by recipient customers and the identity of the customers that did not receive the e-mails (also referred to as “bounces”), (6) a calculation of the percentage of total e-mails sent that are not received (also referred to as “bounced percent”), (7) the identity of any Internet link embedded in the e-mail that is clicked on by customers and the number of times each link is clicked on, (8) the number of and identity of customers who click on an Internet link embedded in the e-mail (also referred to as “clicks” or “click-throughs”), (9) the date and time of day that the link is clicked on, (10) a calculation of the percentage of total e-mails sent in which a customer clicks on an Internet link embedded in the e-mail (also referred to as “click-through percent”), (11) the number and identity of the people who request that their names be removed from the customer information list or database (also referred to as “opt-outs”), (12) a calculation of the percentage of people who request removal of their names from the customer information list or database in relation to the total number of e-mails sent (also referred to as “opt-out percent”), (13) the number of complaints received from recipient customers as the result of a promotion and the identity of the complainants (also referred to as “spam reports”), (14) the number and identity of customers who forward the e-mail to another recipient, (15) the number and identity of people who request to be added to the customer information list or database, (16) the totals for any of the above statistics since a merchant joined the program or any other period of time. Alternatively, any known statistics related to the e-mail can be tracked. In a further alternative wherein the communication is any other media format, the statistics that can be tracked include, but are not limited to, (1) the number of people who request that their names be removed from the customer information list or database, and (2) the number of people who request to be added to the customer information list or database. Alternatively, any known statistics related to the communication can be tracked. An exemplary report providing various statistics as described above for a single promotion for a merchant according to one embodiment of the present invention is depicted in FIG. 6. Further, an exemplary report providing various total statistics as described above for more than one promotion for a merchant according to one embodiment of the present invention is depicted in FIG. 7.

In addition, redemption statistics can also be tracked (block 20 of FIG. 1). According to one embodiment, each merchant can track the number of recipients who use the promotion at the merchant location. In one aspect of the invention, each merchant collects the tracked information and sends it to the system provider. Alternatively, the system provider obtains the tracked information from each merchant. According to one embodiment, the loyalty cards described herein can be used to track redemption statistics through known methods. For example, each time a loyalty card is used at a merchant, the information can be automatically collected and transmitted to the marketing system provider.

In accordance with another aspect of the invention, customer satisfaction statistics can also be tracked (block 21 of FIG. 1). According to one embodiment, the customer information collected from each customer can include customer satisfaction information. For example, the customer satisfaction information can relate to how the customer has rated various characteristics of a merchant during a purchase, such as courteousness, speed of service, quality of product, etc. In one embodiment, the customer satisfaction statistics can then be provided to the merchant.

According to one embodiment, the present invention also includes using the distribution and redemption statistics to optimize the marketing system (block 22 of FIG. 1). That is, the distribution and redemption statistics can be used to optimize the marketing system in several ways, including, but not limited to, (1) determining which promotions are most effective, (2) determining which customers are most likely to utilize a promotion, (3) determining the optimal timing for distributing a promotion (for example, the optimal time of day, week, month, year, etc. to distribute a promotion) to elicit the most purchases or responses, and (4) determining the optimal frequency for distribution of a promotion (for example, the optimal distribution could be daily, weekly, bi-weekly, monthly, yearly, etc.). Alternatively, the statistics can be used to optimize the marketing system in any known way.

In one aspect of the invention, the present marketing system also includes using the customer information collection statistics to optimize the collection of customer information 24. That is, the customer information collection statistics can be used to optimize the marketing system in several ways, including, but not limited to, (1) determining which customer information collection methods are most effective, and (2) determining the optimal timing for collecting customer information. Alternatively, the statistics can be used to optimize the marketing system in any known way. In one embodiment, one method of optimization can occur by comparing the amount and quality of customer information collected by one method to the amount and quality of customer information collected by another method in order to determine the best method of collecting customer information. In this embodiment, any known method for collecting customer information can be compared to any other known method. For example, a merchant may hold a contest to collect customer information and separately may also use a display to collect further customer information. In this embodiment, the results of the two methods can be compared to identify the most successful method for collecting customer information.

Although the present invention has been described with reference to preferred embodiments, persons skilled in the art will recognize that changes may be made in form and detail without departing from the spirit and scope of the invention.

1. A method of community marketing comprising:
collecting customer information from at least two merchants;
categorizing the customer information into at least two predetermined categories; and
distributing a promotion to at least one of the at least two categories.

2. The method of claim 1 further comprising collecting statistics related to the distributing of the promotion.

3. The method of claim 2 further comprising optimizing the method of community marketing based on the statistics.

4. The method of claim 1 further comprising collecting statistics related to the collecting customer information.

5. The method of claim 4 further comprising optimizing the method of community marketing based on the statistics related to the collecting customer information.

6. The method of claim 1 wherein at least one of the at least two predetermined categories is a predetermined merchant category.

7. The method of claim 1 wherein at least one of the at least two predetermined categories is a predetermined community category.

8. The method of claim 1 wherein distributing the promotion further comprises distributing a merchant promotion.

9. The method of claim 1 wherein distributing the promotion further comprises distributing a community promotion.

10. The method of claim 1 wherein distributing the promotion further comprises electronically distributing the promotion.

11. The method of claim 1 further comprising preventing access of the customer information or the at least two predetermined categories to any of the at least two merchants.

12. The method of claim 2 wherein collecting statistics further comprises collecting distribution statistics.

13. The method of claim 2 wherein collecting statistics further comprises collecting redemption statistics.

14. The method of claim 2 wherein collecting statistics further comprises collecting customer satisfaction statistics.

15. The method of claim 1 wherein collecting the customer information further comprises collecting the customer information at a merchant location.

16. The method of claim 1 wherein collecting the customer information further comprises collecting the customer information at a website.

17. The method of claim 1 wherein collecting the customer information further comprises collecting the customer information with an electronic device.

18. The method of claim 1 wherein collecting the customer information further comprises collecting the customer information with a survey.

19. A method of marketing comprising:
collecting customer information from at least two merchants;
categorizing the customer information into at least one predetermined merchant category and into at least one predetermined community category;
distributing a promotion to customers in at least one of the at least one predetermined merchant category or the at least one predetermined community category;
collecting statistics related to the distributing of the promotion; and
optimizing the method of community marketing based on the statistics.

20. The method of claim 19 wherein the promotion is a merchant promotion.

21. The method of claim 19 wherein the promotion is a community promotion.

22. The method of claim 19 wherein distributing the promotion further comprises electronically distributing the promotion.

23. The method of claim 19 further comprising preventing access of the customer information, the at least one predetermined merchant category, or the at least one predetermined community category to any of the at least two merchants.

24. The method of claim 19 wherein collecting statistics further comprises collecting distribution statistics.

25. The method of claim 19 wherein collecting statistics further comprises collecting redemption statistics.

26. The method of claim 19 wherein collecting statistics further comprises collecting customer satisfaction statistics.
